(19) United States
(12) Patent Application Publication
(10) Pub. No.: US 2026/0044853 A1
(43) Pub. Date: Feb. 12, 2026

(54) External Data Verification Based on Multiparty Computation and Quantum-Enabled Trust Mechanism

(71) Applicant: Bank of America Corporation, Charlotte, NC (US)

(72) Inventors: Saurabh Arora, Haryana (IN); Sandeep Kumar Chauhan, Telangana (IN); Puneetha Polasa, Telangana (IN); Mallidi Bhagya Lakshmi Sudha Lavanya, Hyderabad (IN)

(21) Appl. No.: 18/800,277

(22) Filed: Aug. 12, 2024

(51) Int. Cl. G06Q 20/40; G06Q 40/06

(52) U.S. Cl. CPC G06Q 20/401; G06Q 40/06

(57) ABSTRACT

Arrangements for multi-party verification are provided. In some aspects, a computing platform may receive a request to initiate a transaction. The computing platform may retrieve, from a plurality of entities, data related to connectivity between accounts involved in the transaction and/or users thereof. The computing platform may analyze the data in real-time and determine whether connectivity exists. If so, the requested transaction may be processed. If not, additional data may be retrieved from one or more public sources. The computing platform may generate an adjacency matrix based on the retrieved data that may indicate a likelihood of validity of a recipient account to the transaction (e.g., based on adjacency determined from the matrix). The computing platform may compare the likelihood of validity to a threshold and, if the threshold is met, the transaction may be processed. If not, the transaction may be denied.

### BACKGROUND

Aspects of the disclosure relate to electrical computers, systems, and devices for dynamic, real-time data verification based on multiparty data.

Conventional arrangements for executing a fund transfer may be prone to errors. For instance, it can be difficult or impossible to confirm the validity of a recipient account in real-time or near real-time. Conventional arrangements often rely on multiple transfers of minimal amounts to test the recipient account to determine whether it is valid. These arrangements are time consuming and can be prone to errors that result in loss to users. Accordingly, aspects described herein rely on multiparty data to determine a contextual connection between parties of a fund transfer in order to validate the recipient account.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with determining validity of an account in real-time.

In some aspects, a computing platform may receive a request to initiate a transaction. The computing platform may retrieve, from a plurality of entities, data related to connectivity between accounts involved in the transaction and/or users thereof. The computing platform may analyze the data in real-time and determine whether connectivity exists. If so, the requested transaction may be processed.

If connectivity does not exists based on the retrieve data, additional data may be retrieved from one or more public sources. The computing platform may generate an adjacency matrix based on the retrieved data that may indicate a likelihood of validity of a recipient account to the transaction (e.g., based on adjacency determined from the matrix). The computing platform may compare the likelihood of validity to a threshold and, if the threshold is met, the transaction may be processed. If not, the transaction may be denied.

In some examples, the computing platform may execute a data hydration process to cause data related to connectivity (e.g., based on the adjacency matrix, output thereof, or the like) to be imported to one or more systems of the plurality of external entities.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing multi-party verification functions in accordance with one or more aspects described herein;

FIGS. 2A-2E depict an illustrative event sequence for multi-party verification in accordance with one or more aspects described herein;

FIG. 3 illustrates an illustrative method for multi-party verification according to one or more aspects described herein;

FIGS. 4 and 5 illustrate example user interfaces that may be generated according to one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, funds transfers between user accounts may be prone to inaccuracies and inefficiencies. In conventional arrangements, a test transfer is often conducted in order to determine whether the recipient account is valid. These arrangements may be time consuming and may result in loss of the minimal amount if the recipient account is not valid.

Accordingly, aspects described herein provide for real-time, multiparty data analysis to determine validity of a recipient account. In some examples, contextual data associated with users who are parties to the fund transfer may be analyzed to determine whether connectivity exists between the users. If so, the recipient account may be deemed valid. If not, a quantum-enable adjacency matrix may be generated based on a likelihood of connectivity score and a transactional confidence. Based on an output of the quantum-enabled adjacency matrix, a determination of the likelihood of validity of the recipient account is determined. The likelihood of validity may be compared to a threshold to determine whether to process a requested fund transfer or deny the requested fund transfer.

These and various other arrangements will be discussed more fully below.

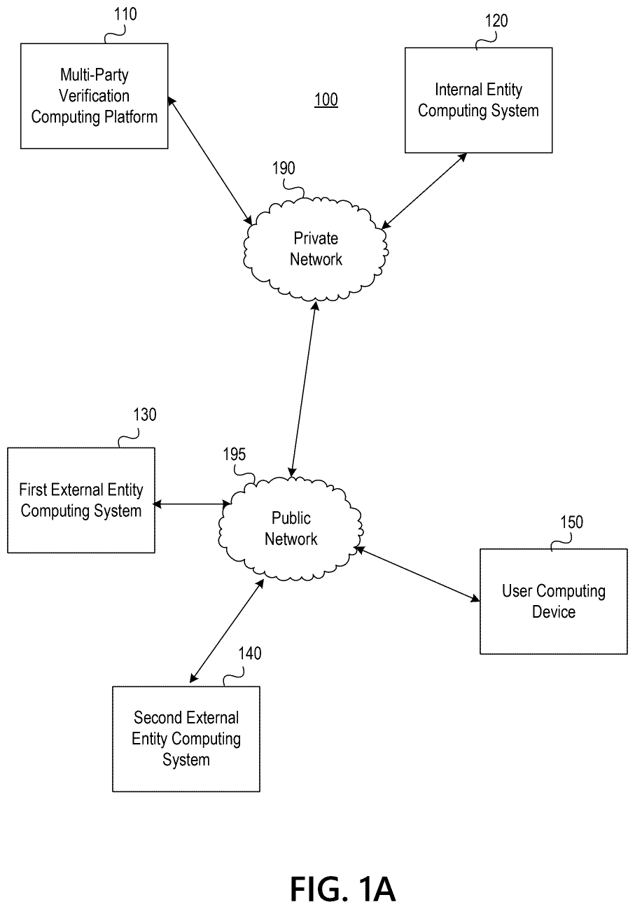

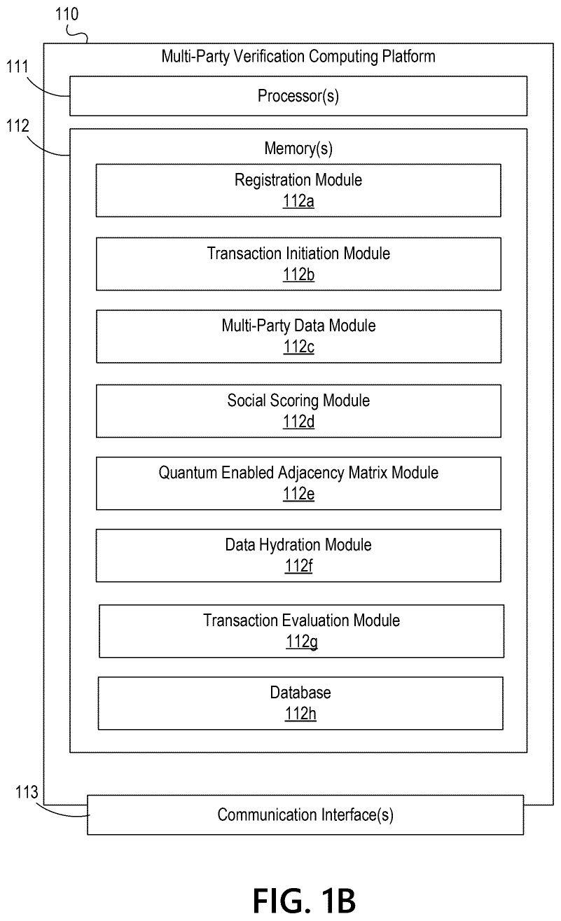

FIGS. 1A-1B depict an illustrative computing environment and devices for implementing multi-party data verification functions in accordance with one or more aspects described herein. Referring to FIG. 1A, computing environment 100 may include one or more computing devices and/or other computing systems. For example, computing environment 100 may include multi-party verification computing platform 110, internal entity computing system 120, first external entity computing system 130, second external entity computing system 140 and user computing device 150.

Although one internal entity computing system 120, two external entity computing systems 130, 140, and one user computing device 150 are shown, any number of systems or devices may be used without departing from the invention.

Multi-party verification computing platform 110 may be configured to perform intelligent, dynamic, real-time multi-party data verification functions. For instance, multi-party verification computing platform 110 may receive a request for a funds transfer from a first party to a second party. The request may be received from a user computing device, such as user computing device 150. Multi-party verification computing platform 110 may determine whether a transfer was executed between the users or to the recipient account previously. If so, and no issues were detected, the request may be processed.

If not, multi-party verification computing platform 110 may retrieve data from a plurality of external sources, internal sources, and the like. For instance, multi-party verification computing platform 110 may retrieve data from internal sources, such as internal entity computing system 120, associated with the recipient account, a user of the recipient account, other accounts associated with the user of the recipient account, and the like. In addition, multi-party verification computing platform 110 may retrieve data from one or more external sources registered with the multi-party verification computing platform 110. For instance, first external entity computing system 130 and/or second external entity computing system 140 may be financial institutions registered with the multi-party verification computing platform 110 and may share available data related to the recipient account, a user of the recipient account, other accounts associated with the user of the recipient account, and the like. In some examples, the shared data may include only an indication that the account is active and valid. In other examples, the shared data may include additional information about the account, user, and the like (e.g., with permission of the user).

If data associated with the recipient account or user of the recipient account is received from the internal and/or external sources and shows the recipient account is valid, the requested fund transfer may be processed. If no data is available from internal or external sources, a likelihood of connectivity score may be determined for the user recipient account and the user sending account. In some examples, publicly available data, such as social media platform data, public government records, and the like, may be retrieved to determine a likelihood of connectivity score. In some examples, quantum computing devices may be used to receive and process the data in order to process the vast amounts of data available in real-time or near real-time. Based on the likelihood of connectivity score, a confidence in the requested fund transfer may be determined. A quantum enabled adjacency matrix may be generated including the likelihood of connectivity score and confidence. Multi-party verification computing platform 110 may compare and output of the matrix to a threshold. If the threshold is met, the fund transfer may be processed. If the threshold is not met, the request may be denied.

Internal entity computing system 120 may be or include one or more computer components (e.g., servers, server blades, memory, processors, or the like) and may execute or host one or more applications or systems associated with a first financial institution. The applications or systems may be associated with storing user account data, processing transactions, transferring funds, updating account ledgers, and the like.

First external entity computing system 130 and/or second external entity computing system 140 may be or include one or more computer components (e.g., servers, server blades, memory, processors, or the like) and may execute or host one or more applications or systems associated with a second financial institution and a third financial institution, respectively. The second and third financial institutions may be different from the first financial institution and external to the enterprise organization associated with the first financial institution and the multi-party verification computing platform 110. The applications or systems may be associated with storing user account data, processing transactions, transferring funds, updating account ledgers, and the like. In some examples, one or more of first external entity computing system 130 and/or second external entity computing system 140 may store or access publicly available data, such as social media data, public government records, and the like.

User computing device 150 may be or include one or more computing devices, such as a laptop computer, desktop computer, smartphone, mobile device, wearable device, or the like and may be configured to communicate with communicate with multi-party verification computing platform 110 and/or request transactions or fund transfers.

As mentioned above, computing environment 100 also may include one or more networks, which may interconnect one or more of multi-party verification computing platform 110, internal entity computing system 120, first external entity computing system 130, second external entity computing system 140, and/or user computing device 150. For example, computing environment 100 may include private network 190. Private network 190 may include one or more sub-networks (e.g., Local Area Networks (LANs), Wide Area Networks (WANs), or the like). Private network 190 may interconnect one or more computing devices associated with the organization. For example, multi-party verification computing platform 110 and internal entity computing system 120 may be connected via private network 190. Computing environment 100 may further include public network 195. Public network 195 may include one or more sub-networks (e.g., Local Area Networks (LANs), Wide Area Networks (WANs), or the like). Public network 195 may interconnect one or more computing devices outside the organization. For example, first external entity computing system 130, second external entity computing system 140, and/or user computing device 150 may be connected via public network 195, which may also connect first external entity computing system 130, second external entity computing system 140, and/or user computing device 150 to devices connected via the private network (e.g., multi-party verification computing platform 110 and internal entity computing system 120).

Referring to FIG. 1B, multi-party verification computing platform 110 may include one or more processors 111, memory 112, and communication interface 113. A data bus may interconnect processor(s) 111, memory 112, and communication interface 113. Communication interface 113 may be a network interface configured to support communication between multi-party verification computing platform 110 and one or more networks (e.g., private network 190, public network 195, or the like). Memory 112 may include one or more program modules having instructions that when executed by processor(s) 111 cause multi-party verification computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of multi-party verification computing platform 110 and/or by different computing devices that may form and/or otherwise make up multi-party verification computing platform 110.

For example, memory 112 may have, store and/or include registration module 112a. Registration module 112a may store instructions and/or data that may cause or enable the multi-party verification computing platform 110 to receive registration data from a plurality of enterprise organizations, such as a plurality of financial institutions. For instance, one or more financial institutions other than the enterprise organization/financial institution associated with the multi-party verification computing platform 110 may request to register with the system. By registering with the system, each additional financial institution may agree to share information related to connectivity between users. For instance, registered financial institutions may share data related to previous transaction history between accounts or users, historical transactions that involve both parties to a transaction, and the like. The data may be shared with permission of the user. Additionally or alternatively, the registered financial institutions might not share transaction data and, instead, may share an indication of whether a previous connectivity exists between the two users or parties to the transactions, between the sender account and recipient account, or the like. Accordingly, in some examples, a binary yes or no indication may be provided by the registered financial institutions.

Multi-party verification computing platform may further have, store and/or include transaction initiation module 112b. Transaction initiation module 112b may store instructions and/or data that may cause or enable the multi-party verification computing platform 110 to receive a request for transaction, such as a transfer of funds from a user account associated with the enterprise organization associated with the multi-party verification computing platform 110 to a recipient account. In some examples, transaction initiation module 112b may determine whether the recipient account is also held by the enterprise organization associated with the multi-party verification computing platform 110. If so, the recipient account may be considered verified in some examples, and the requested transfer may proceed. If not, additional data may be retrieved.

Multi-party verification computing platform 110 may further have, store and/or include multi-party data module 112c. Multi-party data module 112c may store instructions and/or data that may cause or enable the multi-party verification computing platform 110 to retrieve data from one or more registered financial institutions related to the recipient account and/or a user associated with the recipient account. For instance, multi-party data module 112c may generate and transmit a query requesting historical data associated with past transactions between the sender account and the recipient account, between the user associated with the sender account and a user associated with the recipient account, historical transaction data that may indirectly include the user of the sender account and the user of the recipient account or sender account and recipient account, and the like. In some examples, the query may be provided to the registered financial institutions and one or more financial institutions may respond with the requested data and/or with an indication of whether connectivity exists (e.g., previous transactions between the users or accounts, account activity including (directly or indirectly) the users or account, or the like has previous occurred or a record exists of such activity). The multi-party data module 112c may evaluate data received from the registered financial institutions and may determine whether connectivity exists (e.g., previous data exists). If so, the recipient account may be considered valid and the request transfer or transaction may proceed. If no connectivity exists based on the multi-party data, additional likelihood of connectivity scoring may be determined.

For instance, multi-party verification computing platform 110 may further have, store and/or include social scoring module 112d. Social scoring module 112d may store instructions and/or data that may cause or enable the multi-party verification computing platform 110 to retrieve data from a plurality of publicly available sources (e.g., public records, social media platforms, and the like). The retrieved data may be used to generate a likelihood of connectivity score. For instance, based on a number of connections identified in the retrieved data, a frequency of connections, a proximity of connections, and the like, a likelihood of connectivity score indicating a likelihood that the user of the sender account and the user of the recipient account are connected and, accordingly, the recipient account is valid may be generated. In some examples, a confidence factor may also be determined. The confidence factor may be based on proximity of identified connections, frequency of connections, recency of connections, and the like.

Multi-party verification computing platform 110 may further have, store and/or include quantum-enabled adjacency matrix module 112e. Quantum-enabled adjacency matrix module 112e may store instructions and/or data that may cause or enable the multi-party verification computing platform 110 to generate an adjacency matrix indicating a likelihood that the user of the sender account and the user of the recipient account are connected and, accordingly that the recipient account is valid. For instance, based on the likelihood of connectivity score, confidence factor, public data received and/or data from the registered financial institutions, an adjacency matrix may be generated indicating a likelihood that the parties are connected and the recipient account is valid. For instance, the received data, likelihood of connectivity score, confidence factor, and/or the like may be plotted and the adjacency matrix generated based on a number of edges between the vertices. A number of edges may then be determined from the matrix and compared to a threshold to determine whether the recipient account is considered valid. In some examples, the threshold may be determined by the financial institution associated with the sender account (e.g., the sending institution may determine a level of risk appropriate for that institution).

Multi-party verification computing platform 110 may further have, store and/or include data hydration module 112f. Data hydration module 112f may store instructions and/or data that may cause or enable the multi-party verification computing platform 110 to import data from the adjacency matrix, outputs thereof, other data, and the like, to one or more databases associated with the registered financial institutions through a data hydration process. The data hydration process may ensure that data is imported to the databases in a proper place and format for the type of data, database, and the like.

Multi-party verification computing platform 110 may further have, store and/or include transaction evaluation module 112g. Transaction evaluation module 112g may store instructions and/or data that may cause or enable the multi-party verification computing platform 110 to evaluate one or more outputs of the adjacency matrix to determine whether the recipient account is considered valid. For instance, transaction evaluation module 112g may determine a number of edges between vertices from the matrix and compare the number of edges to a threshold to determine whether the recipient account is considered valid. In some examples, the threshold may be determined by the financial institution associated with the sender account (e.g., the sending institution may determine a level of risk appropriate for that institution).

Multi-party verification computing platform 110 may further have, store and/or include database 112h. Database 112h may store data associated with retrieved data from publicly available sources, registered financial institutions, generated adjacency matrices, and/or other data to perform the functions of the multi-party verification computing platform 110.

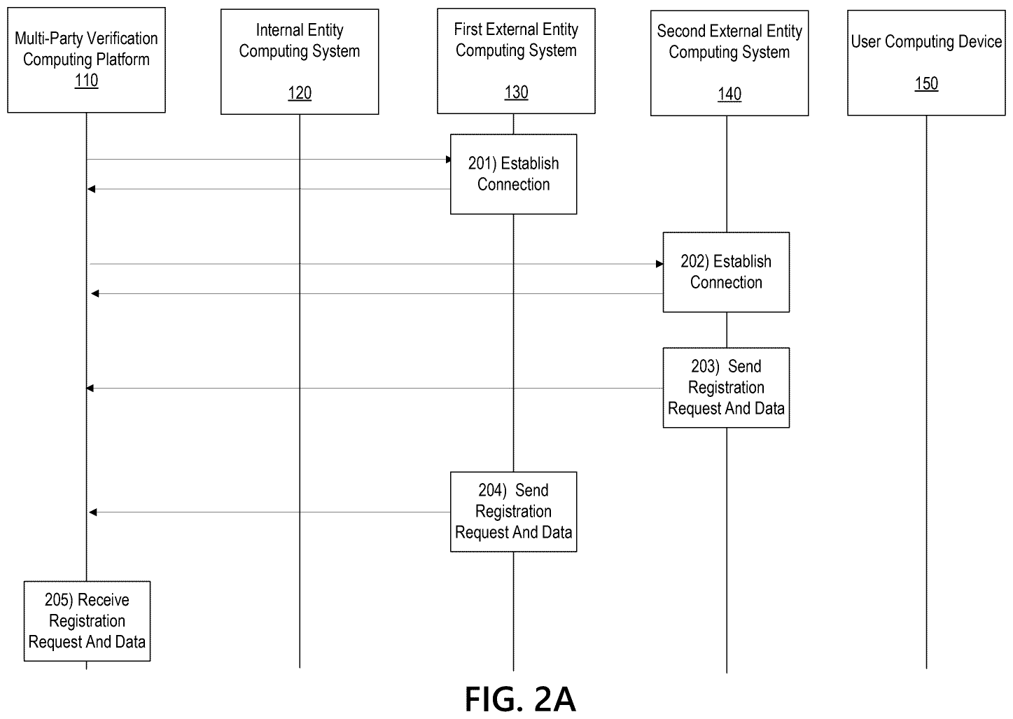

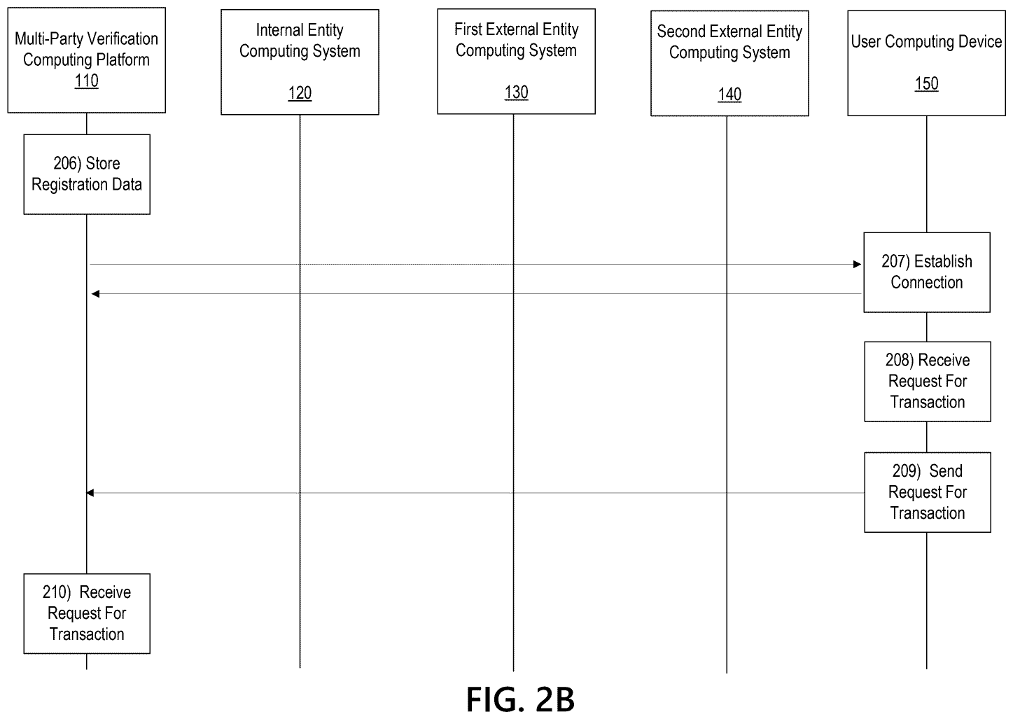

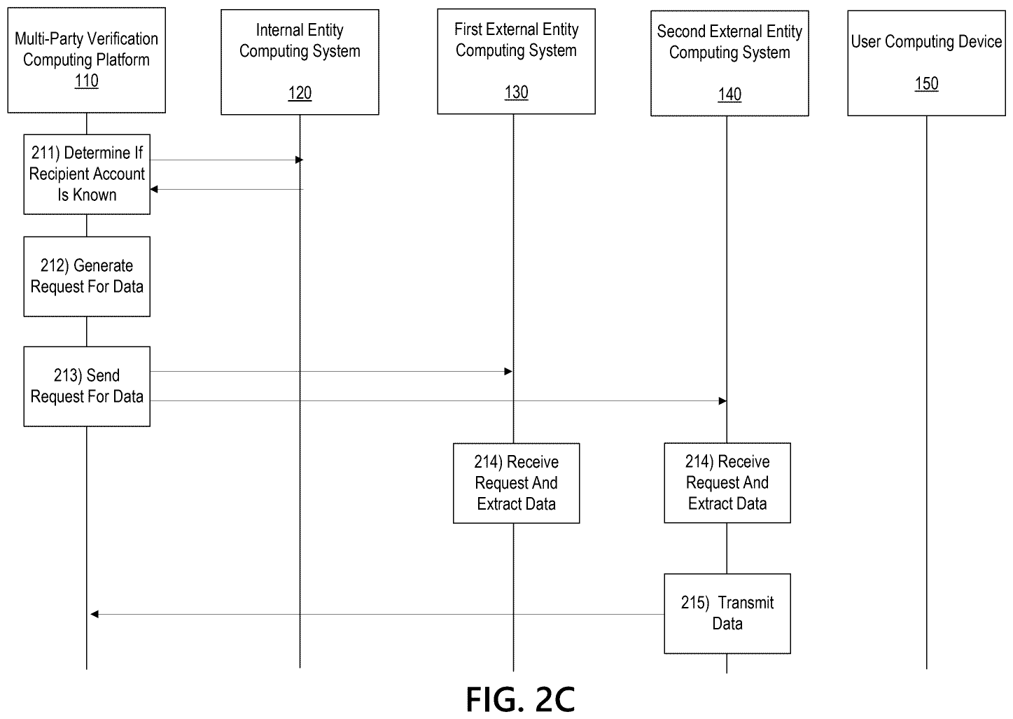

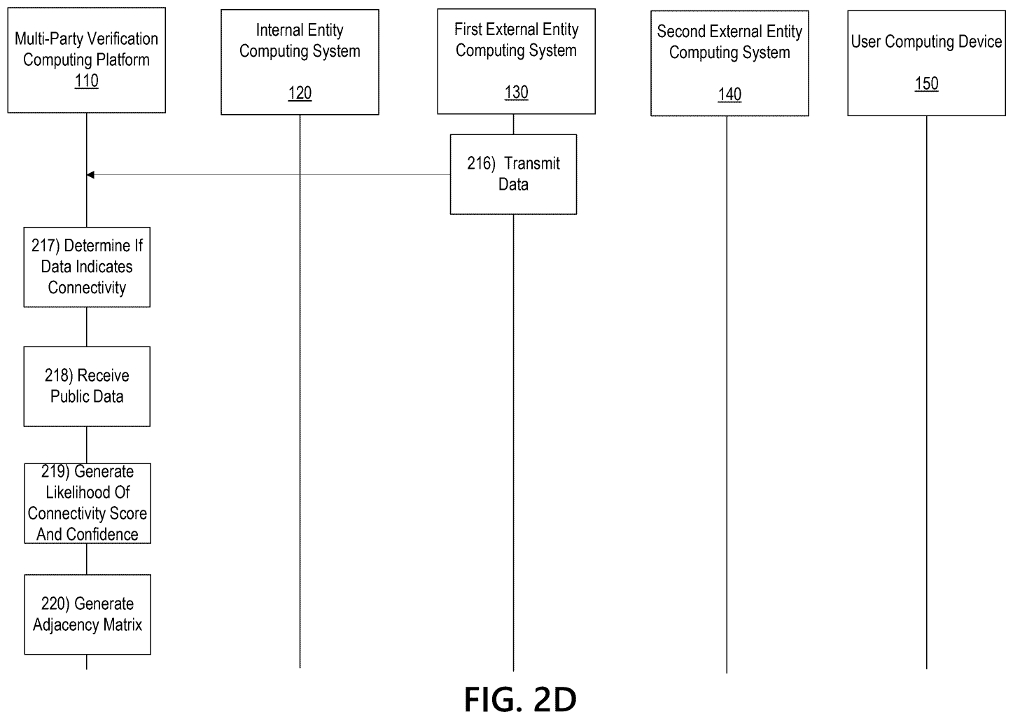

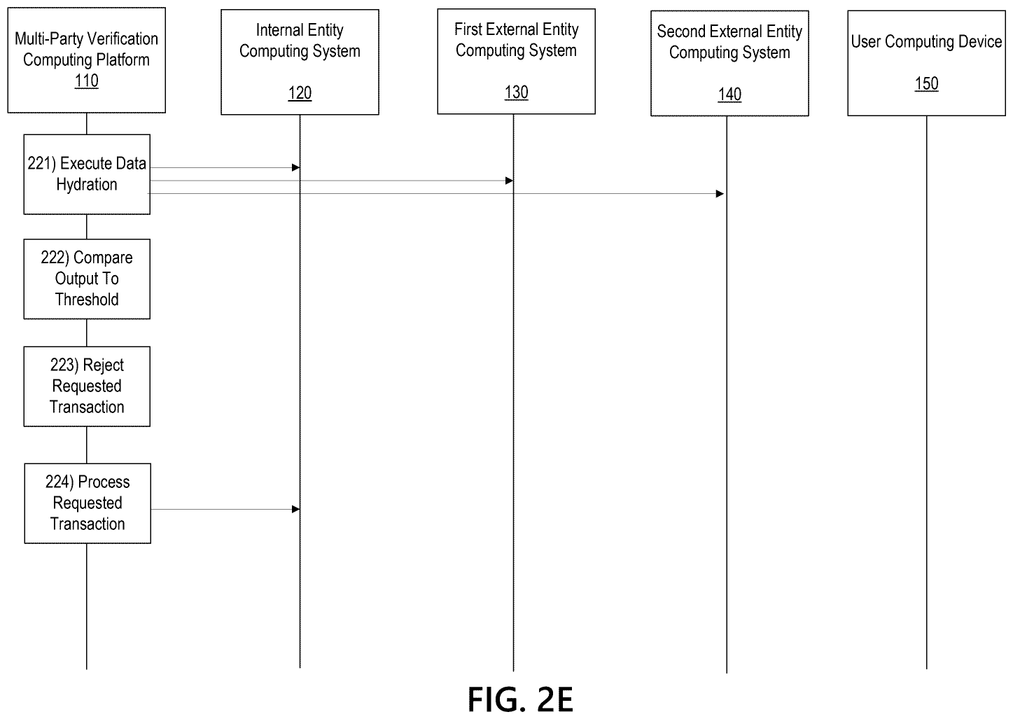

FIGS. 2A-2E depict one example illustrative event sequence for multi-party verification in accordance with one or more aspects described herein. The events shown in the illustrative event sequence are merely one example sequence and additional events may be added, or events may be omitted, without departing from the invention. Further, one or more processes discussed with respect to FIGS. 2A-2F may be performed in real-time or near real-time.

With reference to FIG. 2A, at step 201, first external entity computing system 130 may establish a connection with multi-party verification computing platform 110. For instance, first external entity computing system 130 may establish a first wireless connection with multi-party verification computing platform 110. Upon establishing the first wireless connection, a communication session may be initiated between first external entity computing system 130 and multi-party verification computing platform 110.

At step 202, second external entity computing system 140 may establish a connection with multi-party verification computing platform 110. For instance, second external entity computing system 140 may establish a second wireless connection with multi-party verification computing platform 110. Upon establishing the second wireless connection, a communication session may be initiated between second external entity computing system 140 and multi-party verification computing platform 110.

At step 203, second external entity computing system 140 may send a registration request and registration data to multi-party verification computing platform 110. For instance, second external entity computing system 140 may request to register with multi-party verification computing platform 110 to access the multi-party verification arrangements described herein. Second external entity computing system 140 may transmit or send registration data, such as entity identifier, device identifiers, and the like, to multi-party verification computing platform 110 to register with the system. In some examples, the data and request may be sent during the communication session initiated upon establishing the second wireless connection.

At step 204, first external entity computing system 130 may send a registration request and registration data to multi-party verification computing platform 110. For instance, first external entity computing system 130 may request to register with multi-party verification computing platform 110 to access the multi-party verification arrangements described herein. First external entity computing system 130 may transmit or send registration data, such as entity identifier, device identifiers, and the like, to multi-party verification computing platform 110 to register with the system. In some examples, the data and request may be sent during the communication session initiated upon establishing the first wireless connection.

At step 205, multi-party verification computing platform 110 may receive the request for registration and registration data sent by first external entity computing system 130 and second external entity computing system 140.

With reference to FIG. 2B, at step 206, multi-party verification computing platform 110 may store the registration data. For instance, multi-party verification computing platform 110 may modify a database, such as database 112h, to store the registration data associated with each external entity (e.g., financial institution or other entity).

At step 207, user computing device 150 may establish a connection with multi-party verification computing platform 110. For instance, user computing device 150 may establish a third wireless connection with multi-party verification computing platform 110. Upon establishing the third wireless connection, a communication session may be initiated between user computing device 150 and multi-party verification computing platform 110.

At step 208, user computing device 150 may receive a request for a transaction. For instance, user computing device 150 may receive a request for a transaction via an application executing on the user computing device 150, via an online application, or the like. The request may be received via a user input device such as a touchscreen, keypad, or the like, of the user computing device 150. In some examples, the transaction may include a request to transfer funds from a sender account to a recipient account.

Although the arrangements described are based on a user requesting a transaction via the user computing device 150, in some examples, the request may be received via other devices, such as an automated teller machine (ATM).

At step 209, user computing device 150 may transmit or send the request for transaction and associated transaction details (e.g., sender account, recipient account, user associated with recipient account, and the like).

At step 210, multi-party verification computing platform 110 may receive the request for transaction.

With reference to FIG. 2C, at step 211, multi-party verification computing platform 110 may determine whether the recipient account is known to the enterprise organization associated with the multi-party verification computing platform 110. For instance, multi-party verification computing platform 110 may communicate with one or more internal systems, such as internal entity computing system 120, to determine whether the recipient account is held by the enterprise organization. If so, the recipient account may be considered validated and the process may proceed to step 224 in FIG. 2E to process the requested transaction.

If, at step 211, the recipient account is not known by the enterprise organization, at step 212, multi-party verification computing platform 110 may generate a request for data. For instance, multi-party verification computing platform 110 may generate a request for data associated with historical transactions between the sender account and recipient account, interactions between a user of the sender account and a user of the recipient account, indirect (e.g., through one or more third parties) interactions between the user of the sender account and the user of the recipient account or the sender account and the recipient account, and the like).

At step 213, multi-party verification computing platform 110 may transmit or send the request for data to one or more external entities, such as first external entity computing system 130, second external entity computing system 140, and the like.

At step 214, first external entity computing system 130 and second external entity computing system 140 may receive the request for data and extract the requested data. In some examples, extracting the requested data may include extracting the historical data requested. Additionally or alternative, first external entity computing system 130 and second external entity computing system 140 may retrieve the data, analyze the data to determine whether connectivity exists between the user of the sender account and the user of the recipient account, and may generate an indication of whether or not connectivity exists.

At step 215, second external entity computing system 140 may transmit or send the requested data and/or the generated indication of whether connectivity exists.

With reference to FIG. 2D, at step 216, first external entity computing system 130 may transmit or send the requested data and/or the generated indication of whether connectivity exists.

At step 217, multi-party verification computing platform 110 may receive the data and/or indication sent by first external entity computing system 130 and second external entity computing system 140 and may analyze the data to determine whether connectivity exists. If so, the process may proceed to step 224 in FIG. 2E and the requested transaction may be processed.

If, at step 217, connectivity does not exist, at step 218, multi-party verification computing platform 110 may retrieve publicly available data. For instance, multi-party verification computing platform 110 may retrieve, from publicly available sources, social media data, public government records, and the like, that may indicate a connection between the user of the sender account and the user of the recipient account. In some examples, the data retrieved may provide a basis to determine that a user associated with a recipient account is an actual user rather than a threat actor.

At step 219, based on the retrieved publicly available data, a likelihood of connectivity score may be determined. In some examples, the likelihood of connectivity score may be based on a number of interactions between the users in the data, a frequency of interactions, or the like. In some examples, a confidence score may also be generated and associated with the likelihood of connectivity score. In some examples, the likelihood of connectivity score may also be based on a likelihood that a user associated with an account is an actual user, rather than a threat actor. For instance, availability of social media data, and the like, may indicate that the user is an actual user rather than a threat actor that has only an account and no other online presence.

In some examples, the likelihood of connectivity score may be determined based on a sum of various factors or data points available. For instance, the likelihood of connectivity score may include a sum of factors such as, whether one or more social media platforms include a profile for a user, a number of social media platforms having a profile for a user, direct social media connections between users who are parties to the transactions, indirect social media connections between users who are parties to the transaction (e.g., connections via one or more third parties), government records indicating home or other property ownership, and the like.

At step 220, multi-party verification computing platform 110 may generate a quantum-enabled adjacency matrix. For instance, multi-party verification computing platform 110 may generate an adjacency matrix based on the retrieved data (e.g., from public sources, registered financial institutions, and the like) and/or the likelihood of connectivity score. In some examples, due to the volume of data being processed, and the need to process the data quickly, quantum computing may be used to generate the adjacency matrix.

In some examples, while the system is connecting to a quantum layer, the system may identify which edge node or network to connect to to perform the analysis. Accordingly, the system may select an optimum node or network for processing. Further, in some examples, a software defined network may be used to control an amount of data being processed, determine a number of compute nodes to use for processing, how to arrange the nodes for processing, execute the data hydration process described below, and the like.

With reference to FIG. 2E, at step 221, multi-party verification computing platform 110 may execute a data hydration process. For instance, multi-party verification computing platform 110 may import data related to connectivity between the users or accounts (e.g., as determined from the likelihood of connectivity score, adjacency matrix, and the like) to one or more databases associated with registered financial institutions (e.g., databases at first external entity computing system 130, second external entity computing system 140, or the like). In some examples, data may also be imported to internal entity computing system 120. The use of data hydration may ensure the data is stored in a proper location and format based on the type of data, content of the data, entity to which the data is being imported, and the like.

At step 222, an output of the adjacency matrix may be compared to a threshold for validity of the recipient account. For instance, a number of edges between vertices may be determined from the adjacency matrix and may be compared to a threshold. In some examples, the threshold may be determined by the financial institution associated with the sender account (e.g., based on an amount of risk they are willing to assume). If the number of edges does not meet or exceed the threshold, the requested transaction may be rejected at step 223 and a notification may be transmitted or sent to the user computing device 150. FIG. 5 illustrates one example notification 500 that may be generated and transmitted to user computing device 150. The notification 500 includes an indication that the requested transaction was denied and provides an option to attempt the transaction again.

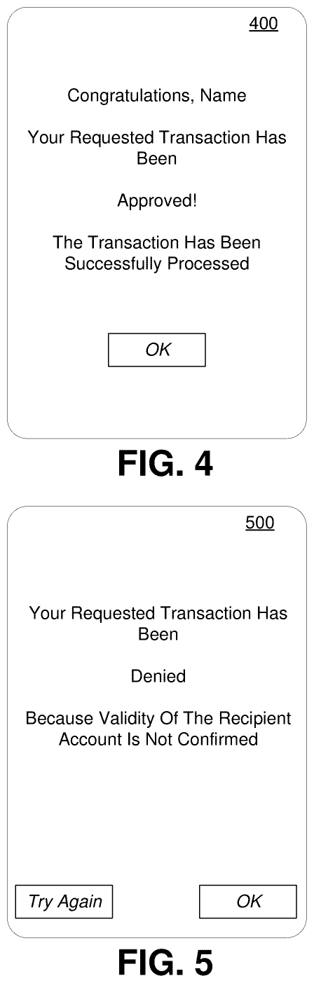

If the number of edges meets or exceeds the threshold, the requested transaction may be processed at step 224. For instance, multi-party verification computing platform 110 may generate and send an instruction to internal entity computing system 120 causing the internal entity computing system 120 to transfer funds from the sender account to the recipient account, update the account ledger associated with the sender account, and the like. In some examples, a notification of the transaction processing may be generated and transmitted to user computing device 150. For instance, FIG. 4 illustrates one example notification 400 that includes an indication that the requested transaction was approved and successfully processed.

In some examples, the final approval or rejection decision (e.g., based on the particular threshold) and/or whether the transaction was successfully completed, may also be imported to the financial institution systems using the data hydration process described herein.

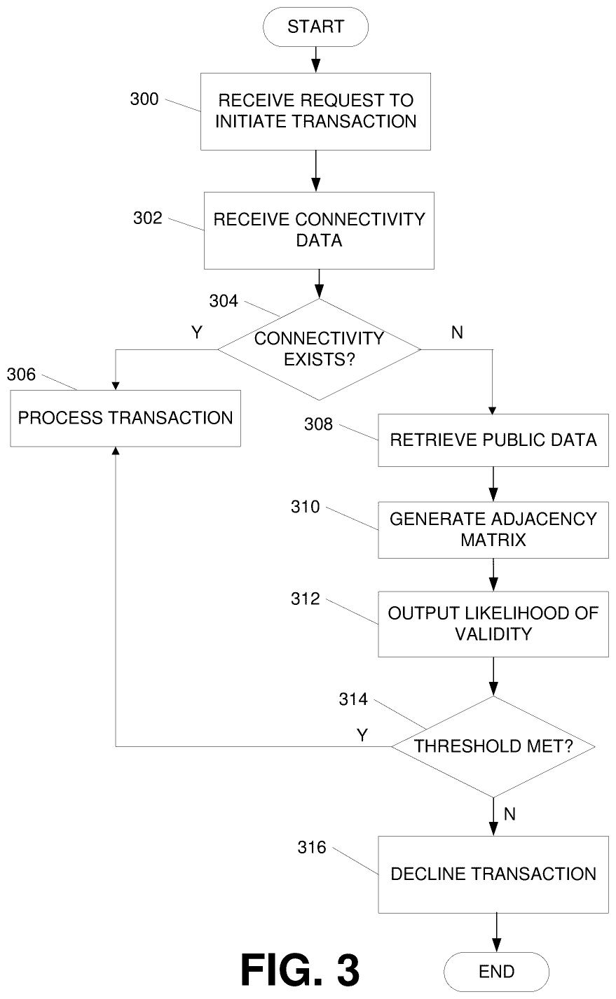

FIG. 3 is a flow chart illustrating one example method of multi-party data verification in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, multi-party verification computing platform 110 may receive a request to process a transaction, such as a transfer of funds from a sender account to a recipient account. The request may be received from a user computing device 150. If the recipient account is held by a same financial institution as the sender account, the request may be processed and the process may end. If the accounts are held by different financial institutions, the process may continue.

At step 302, multi-party verification computing platform 110 may receive connectivity data associated with the sender account, recipient account and users thereof. For instance, data may be received from internal sources (e.g., internal entity computing system 120) and/or external sources (e.g., first external entity computing system 130, second external entity computing system 140, and the like) related to historical interactions between the accounts, users of the accounts, third party transactions that may include the accounts, and the like.

At step 304, multi-party verification computing platform 110 may analyze the data to determine whether connectivity exists (e.g., whether a sufficient connection exists between the user of the sender account and the user of the recipient account to determine that the recipient account is valid). If so, at step 306, the requested transaction may be authorized and processed.

If, at step 304, sufficient connectivity does not exist, in some examples, publicly available data may be retrieved from one or more public sources at step 308. For instance, social media platform data and/or public records may be retrieved. In some examples, additional data related to indirect connections between the sender and recipient (e.g., sender transacted with party 3 who also transacted with the recipient) may be retrieved. In some examples, this data may be used to determine a likelihood of connectivity score. The score may be used to identify a confidence in the transaction. In some examples, a score may be generated for each identified interaction (e.g., direct or indirect) and a confidence level may be associated with each score.

At step 310, multi-party verification computing platform 110 may generate an adjacency matrix. The adjacency matrix may be generated based on the publicly available data, data from the one or more internal or external entities, and the like. In some examples, the adjacency matrix may be further based on the likelihood of connectivity score.

At step 312, a likelihood of validity may be associated with an output of the adjacency matrix. For instance, a number of edges between vertices may be identified and indicate a likelihood of validity of the recipient account (e.g., based on connectivity between users as determined from the adjacency matrix).

At step 314, the likelihood of validity may be compared to a threshold to determine whether sufficient trust exists and the recipient account is valid. In some examples, the threshold may be unique to an entity associated with a sender account and/or may be customized by that entity. If, at step 314, the likelihood of validity meets or exceeds the threshold, the process may proceed to step 306 and the transaction may be authorized and/or processed. If, at step 314, the likelihood of validity does not meet or exceed the threshold, the requested transaction may be denied at step 316.

In some examples, the data used to generate the adjacency matrix and output of the matrix may be fed back to one or more of internal entity computing system 120, first external entity computing system 130, and/or second external entity computing system 140 using a data hydration process. Accordingly, in a next occurrence of a request to transfer funds to the recipient account, connectivity data may be available for analysis based on processing or denial of this transaction As discussed herein, aspects described are directed to using multi-party data to determine a validity or verify a recipient account. By relying on data from multiple sources, and using quantum computing, vast amounts of data may be analyzed in real-time or near real-time in order to determine validity and process or reject a transaction in real-time for a user (e.g., with minimal delays to the requesting user).

Although various aspects described herein are described in the context of a transfer of funds from a sender account to a recipient account, aspects described may be used in other contexts as well. For instance, in setting up an online or automatic payment, in conventional arrangements a user may provide a cancelled check to the payee entity in order to provide proof of the valid account. However, the arrangements provided herein may be used to validate an account in real-time by the payee entity, which may improve accuracy and efficiency.

Further, while the arrangements provided may be used in situations in which there is limited connectivity between users or account (e.g., few interactions, no recent interactions, or the like), the arrangements may provide confidence in validity of an account when no connectivity is detected (e.g., no history of interaction between users or accounts). Accordingly, the arrangements provide confidence, in real-time, that funds are being transferred to a correct, legitimate account, even in situations where no previous interactions are detected (e.g., first time transfer).

Further, while various aspects are described as determining connectivity based on interactions between the two parties to the transaction, in some examples, one or more third party connections may also be considered. For instance, if party A has transferred funds to party B and party B has transferred funds to party C, then an indirect connection may be identified between party A and party C because of their common connection with party B. Accordingly, quantum analysis of the data may enable detection of more complex interactions between parties while generating an accept or reject output in real-time.

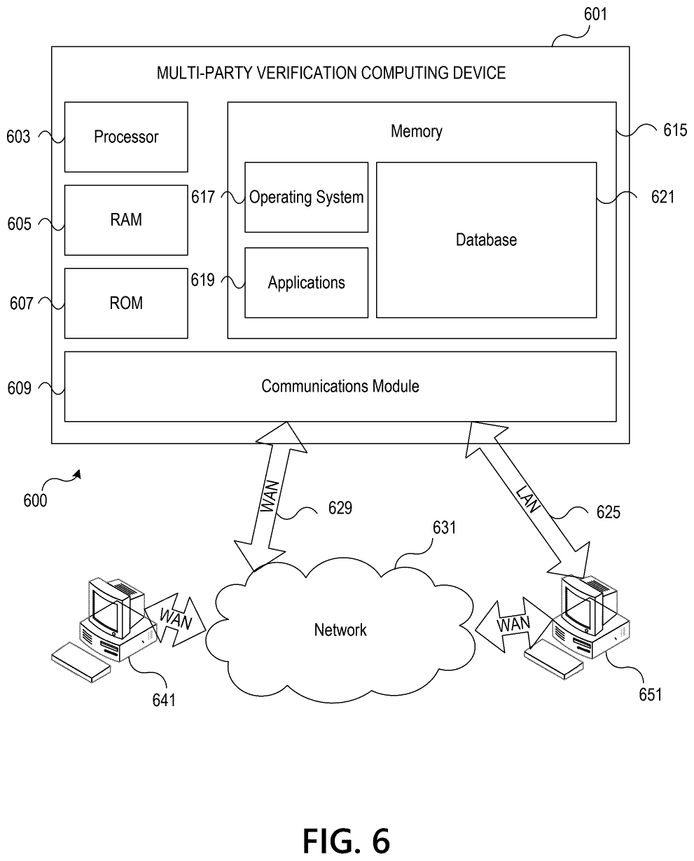

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include multi-party verification computing device 601 having processor 603 for controlling overall operation of multi-party verification computing device 601 and its associated components, including Random Access Memory (RAM) 605, Read-Only Memory (ROM) 607, communications module 609, and memory 615. Multi-party verification computing device 601 may include a variety of computer readable media. Computer readable media may be any available media that may be accessed by multi-party verification computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by multi-party verification computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on multi-party verification computing device 601. Such a processor may execute computer-executable instructions stored on a computer-readable medium.

Software may be stored within memory 615 and/or storage to provide instructions to processor 603 for enabling multi-party verification computing device 601 to perform various functions as discussed herein. For example, memory 615 may store software used by multi-party verification computing device 601, such as operating system 617, application programs 619, and associated database 621. Also, some or all of the computer executable instructions for multi-party verification computing device 601 may be embodied in hardware or firmware. Although not shown, RAM 605 may include one or more applications representing the application data stored in RAM 605 while multi-party verification computing device 601 is on and corresponding software applications (e.g., software tasks) are running on multi-party verification computing device 601.

Communications module 609 may include a microphone, keypad, touch screen, and/or stylus through which a user of multi-party verification computing device 601 may provide input, and may also include one or more of a speaker for providing audio output and a video display device for providing textual, audiovisual and/or graphical output. Computing system environment 600 may also include optical scanners (not shown).

Multi-party verification computing device 601 may operate in a networked environment supporting connections to one or more remote computing devices, such as computing devices 641 and 651. Computing devices 641 and 651 may be personal computing devices or servers that include any or all of the elements described above relative to multi-party verification computing device 601.

The network connections depicted in FIG. 6 may include Local Area Network (LAN) 625 and Wide Area Network (WAN) 629, as well as other networks. When used in a LAN networking environment, multi-party verification computing device 601 may be connected to LAN 625 through a network interface or adapter in communications module 609. When used in a WAN networking environment, multi-party verification computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive, from a user computing device, a request to initiate a transaction, wherein the request includes transaction details including a recipient account;
receive, from a plurality of entities, data related to connectivity between a first party to the transaction and a second party to the transaction;
analyze, in real-time, the data related to connectivity between the first party and the second party;
determine, based on the analyzing and in real-time, whether connectivity exists between the first party and the second party;
responsive to determining that connectivity exits, authorize the transaction and process the transaction;
responsive to determining that connectivity does not exist:
retrieve publicly available data related to the first party and the second party;
generate, using quantum computing, an adjacency matrix indicating a likelihood of connectivity, wherein the adjacency matrix is based on the publicly available data related to the first party and the second party;
output, based on the adjacency matrix, a likelihood of validity of the recipient account;
compare the likelihood of validity to a threshold;
responsive to the likelihood of validity meeting or exceeding threshold, authorize the transaction and process the transaction; and
responsive to the likelihood of validity not meeting or exceeding the threshold, decline the request to initiate the transaction.

2. The computing platform of claim 1, wherein the threshold is specific to an entity associated with a sender account associated with the transaction.

3. The computing platform of claim 2, wherein the threshold is customized by the entity associated with the sender account associated with the transaction.

4. The computing platform of claim 1, further including instructions that, when executed, cause the computing platform to:
generate, in real-time, a likelihood of connectivity score based on the publicly available data.

5. The computing platform of claim 4, wherein the adjacency matrix is further based on the likelihood of connectivity score.

6. The computing platform of claim 1, further including instructions that, when executed, cause the computing platform to:
execute a data hydration process causing data related to connectivity to be imported to one or more entities of the plurality of entities.

7. The computing platform of claim 1, wherein the plurality of entities includes a plurality of registered financial institutions.

8. A method, comprising:
receiving, by a computing platform, the computing platform having at least one processor, and memory, and from a user computing device, a request to initiate a transaction, wherein the request includes transaction details including a recipient account;
receiving, by the at least one processor and from a plurality of entities, data related to connectivity between a first party to the transaction and a second party to the transaction;
analyzing, by the at least one processor and in real-time, the data related to connectivity between the first party and the second party;
determining, by the at least one processor and based on the analyzing and in real-time, whether connectivity exists between the first party and the second party;
responsive to determining that connectivity exits, authorize, by the at least one processor, the transaction and process the transaction;
responsive to determining that connectivity does not exist:
retrieving, by the at least one processor, publicly available data related to the first party and the second party;
generating, using quantum computing, an adjacency matrix indicating a likelihood of connectivity, wherein the adjacency matrix is based on the publicly available data related to the first party and the second party;
outputting, by the at least one processor and based on the adjacency matrix, a likelihood of validity of the recipient account;
comparing, by the at least one processor, the likelihood of validity to a threshold;
responsive to the likelihood of validity meeting or exceeding threshold, authorizing, by the at least one processor, the transaction and process the transaction; and
responsive to the likelihood of validity not meeting or exceeding the threshold, declining, by the at least one processor, the request to initiate the transaction.

9. The method of claim 8, wherein the threshold is specific to an entity associated with a sender account associated with the transaction.

10. The method of claim 9, wherein the threshold is customized by the entity associated with the sender account associated with the transaction.

11. The method of claim 8, further including:
generating, by the at least one processor and in real-time, a likelihood of connectivity score based on the publicly available data.

12. The method of claim 11, wherein the adjacency matrix is further based on the likelihood of connectivity score.

13. The method of claim 8, further including:
executing, by the at least one processor, a data hydration process causing data related to connectivity to be imported to one or more entities of the plurality of entities.

14. The method of claim 8, wherein the plurality of entities includes a plurality of registered financial institutions.

15. One or more non-transitory computer-readable media storing instructions that, when executed by a computing platform comprising at least one processor, memory, and a communication interface, cause the computing platform to:
receive, from a user computing device, a request to initiate a transaction, wherein the request includes transaction details including a recipient account;
receive, from a plurality of entities, data related to connectivity between a first party to the transaction and a second party to the transaction;
analyze, in real-time, the data related to connectivity between the first party and the second party;
determine, based on the analyzing and in real-time, whether connectivity exists between the first party and the second party;
responsive to determining that connectivity exits, authorize the transaction and process the transaction;
responsive to determining that connectivity does not exist:
retrieve publicly available data related to the first party and the second party;
generate, using quantum computing, an adjacency matrix indicating a likelihood of connectivity, wherein the adjacency matrix is based on the publicly available data related to the first party and the second party;
output, based on the adjacency matrix, a likelihood of validity of the recipient account;
compare the likelihood of validity to a threshold;
responsive to the likelihood of validity meeting or exceeding threshold, authorize the transaction and process the transaction; and
responsive to the likelihood of validity not meeting or exceeding the threshold, decline the request to initiate the transaction.

16. The one or more non-transitory computer-readable media of claim 15, wherein the threshold is specific to an entity associated with a sender account associated with the transaction.

17. The one or more non-transitory computer-readable media of claim 16, wherein the threshold is customized by the entity associated with the sender account associated with the transaction.

18. The one or more non-transitory computer-readable media of claim 15, further including instructions that, when executed, cause the computing platform to:
generate, in real-time, a likelihood of connectivity score based on the publicly available data.

19. The one or more non-transitory computer-readable media of claim 18, wherein the adjacency matrix is further based on the likelihood of connectivity score.

20. The one or more non-transitory computer-readable media of claim 15, further including instructions that, when executed, cause the computing platform to:
execute a data hydration process causing data related to connectivity to be imported to one or more entities of the plurality of entities.
